(19) United States
(12) Patent Application Publication
(10) Pub. No.: US 2003/0062430 A1
(43) Pub. Date: Apr. 3, 2003

(54) Mobile power washing system

(75) Inventor: Donald J. Cook, San Antonio, TX (US)

Correspondence Address: Richard R. Ruble, JACKSON WALKER L.L.P., Suite 2100, 112 E. Pecan Street, San Antonio, TX, 78205, US

(73) Assignee: Steam Brite Supply, Inc.

(21) Appl. No.: 10/253,331

(22) Filed: Sep. 24, 2002

Related U.S. Application Data
(60) Provisional application No. 60/325,697, filed on Sep. 28, 2001.

(51) Int. Cl. B05B 3/04

(52) U.S. Cl. 239/754; 239/251

(57) ABSTRACT

The present invention provides a power washing system capable of indoor and outdoor operation while remaining convenient for use by the consumer. The present invention provides a housing designed to move over surface areas to be cleaned and adapted for spraying and retrieving water under high pressure. The housing being equipped with one or more bulkhead fittings capable of receiving vacuum hoses. These vacuum hoses may be attached to the housing such that waste water created during cleaning operations may be recovered and drawn upwardly through the vacuum hoses. The housing is attached to a support member having a trigger member adapted to control water flow through one or more water hoses attached thereto.

This utility patent application is based on a provisional patent application entitled “Mobile Power Washing System”, Ser. No. 60/325,697, filed on Sep. 28, 2001.

### FIELD OF THE INVENTION

The present invention relates generally to a mobile power washing system that uses sprayed water for cleaning flat surfaces such as concrete, asphalt, and other hard surfaces, and more particularly, to a mobile power washing system having a system capable of recovering the sprayed water such that the system may be utilized for indoor and outdoor residential and commercial cleaning.

### BACKGROUND OF THE INVENTION

Apparatus and methods for selectively cleaning flat surfaces using mobile power washing systems are well known in the art. Known power washing systems generally spray water at high rotating speeds to clean flat surfaces and include a water storage means for holding the water to be used for cleaning, a water pumping system used for pumping and pressurizing the water from the storage means, and a water sprayer for spraying the water onto the surfaces. This power wash system can further include a water heating system for heating the water so that high temperature as well as high pressure water is provided for cleaning surfaces.

Known power washing systems are often bulky and difficult to use without extensive training. For example, many known systems require a series of wheels to allow the user to move the water spraying portion of the system over surfaces to be cleaned. In addition, many known systems require the user to operate of a variety of equipment in order to begin washing. For example, to operate many known systems, the consumer must have a working knowledge of how to operate 1) the power washing wand, 2) the water supply system and 3) the water heating system. This is especially burdensome for small business owners who have neither the time nor the money to learn how to operate this equipment.

The operation of a power washer creates waste water that must be properly disposed of or recycled. Accordingly, the use of known power washers is often practical only for outdoor applications. There remains a need for a power washing system capable of being used both indoors and outdoors while remaining convenient for use by the consumer.

### SUMMARY OF THE INVENTION

Set forth below is a brief summary of the invention in order to solve the foregoing problems and achieve the foregoing and other objects, benefits, and advantages in accordance with the purposes of the present invention as embodied and broadly described herein.

Accordingly, the present invention provides a power washing system capable of indoor and outdoor use while remaining convenient for average consumers. This is accomplished through the use of a housing having inner surfaces comprising a generally concave configuration. The housing of the present invention is equipped with an adjustable water dispersing system capable of spraying high pressure water onto resilient and/or hard surfaces.

The housing of the present invention provides one or more bulkhead fittings capable of receiving vacuum hoses. By attaching one or more vacuum hoses to the housing of the present invention, the consumer is able to create a power washing system ideal for indoor use. Specifically, water containing dirt or other particles gleaned from the cleaning surface is drawn from the surface into the vacuum hoses. Thus, the present invention may efficiently clean indoor surfaces without leaving undesirable residue upon the cleaning surface.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of one embodiment of the power washing system of the present invention.

FIG. 2 is a perspective view of the bottom portion of one embodiment of the power washing system of the present invention illustrating the dispersement member.

FIG. 3 is a side elevation view of a bulkhead fitting used in conjunction with the present invention in one embodiment.

FIG. 4 is a perspective view of the housing of one embodiment of the present invention illustrating the brush lip attachment.

### DETAILED DESCRIPTION OF THE INVENTION

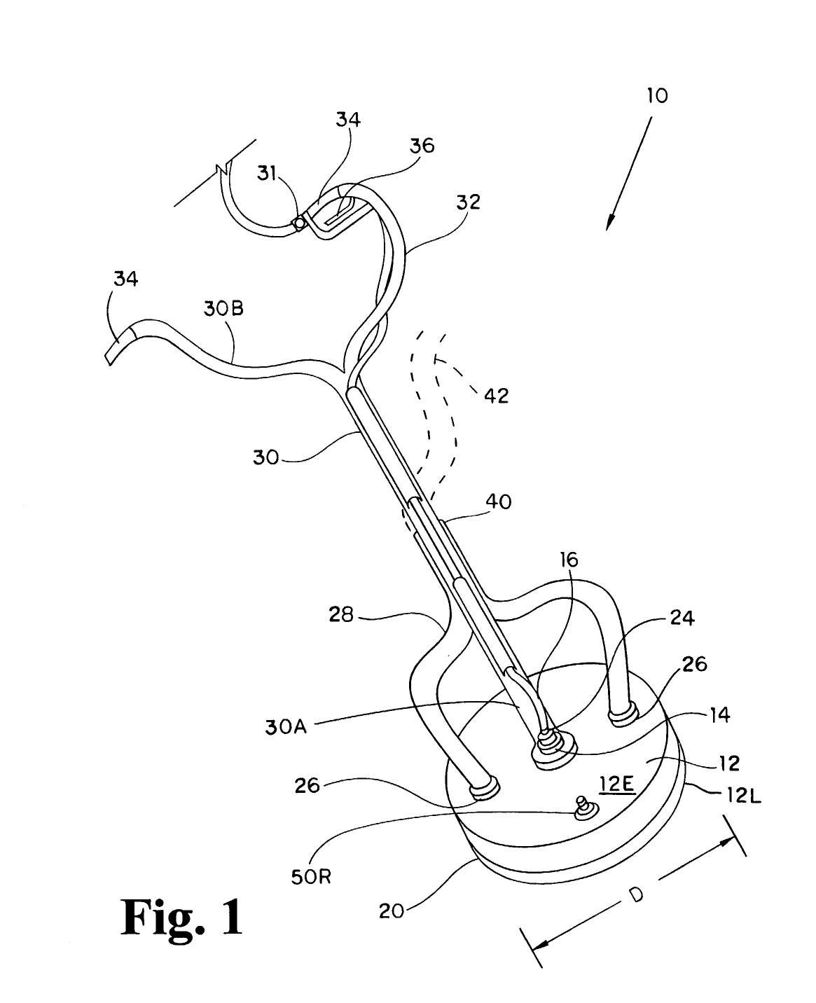

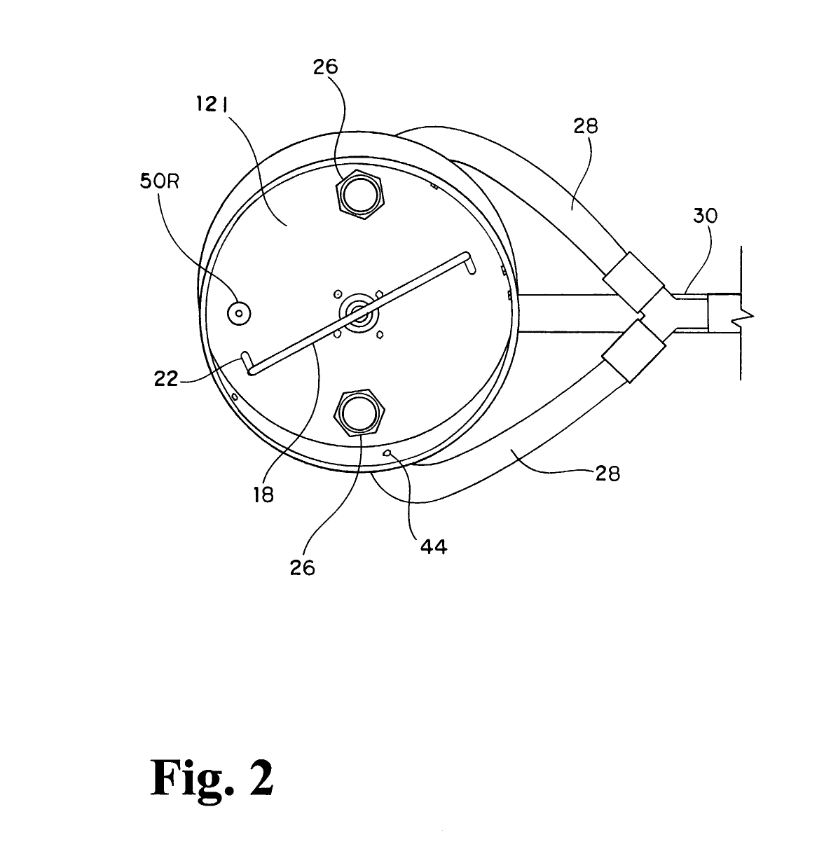

Referring to the Figures, the present invention is herein described as a mobile power washing system (10) capable of moving over surface areas to be cleaned and adapted for spraying and retrieving water under high pressure. Referring to FIGS. 1 and 2, the system (10) of the present invention provides a housing (12) having internal and external surfaces (12I and 12E, respectively). In one embodiment, the internal surfaces (12I) of the present invention have a generally concave configuration designed to restrain high pressure water to a confined area during operation of the power washing system (10). In another embodiment, the housing (10) of the present invention is composed of polypropylene and has a diameter (D) of about sixteen inches.

The housing of the present invention has a neck portion (14) equipped with an input water hose (16). The input water hose of the present invention is, in turn, releasably attached to a rotatable water dispersement member (18) capable of receiving and rotatably delivering high pressure water to the surface areas to be cleaned. The housing (12) of the present invention is further equipped with an abrasion lip (20) sized for attachment to the lower portion (12L) of the housing (12). The abrasion lip (20) allows the housing (12) of the present invention to be pulled, pushed and/or moved in a side to side direction by the consumer without damaging the housing. In one embodiment, the abrasion lip (20) of the present invention is composed of an ultra high molecular weight plastic to provide the system (10) with added durability without the use of heavy attachments.

The water dispersement member (18) of the present invention is equipped with one or more adjustable water jets (22). The present invention allows the angle of the water jets (22) to be adjusted with respect to the cleaning surface. In one embodiment, forty five degree, ¼″ street brass pieces (not shown) are provided for installation between each water jet (22) and the dispersement member (18) to effectuate changes in the angle of the water jets with respect to the cleaning surface and/or to effectuate an increase in the revolutions per minute capability of the dispersement member (18). The present invention also allows the position of the dispersement member (18) to be adjusted. In one embodiment, the height of the dispersement member (18) may be adjusted by loosening or tightening a screw (24) attached to the neck (16) portion of the housing (12).

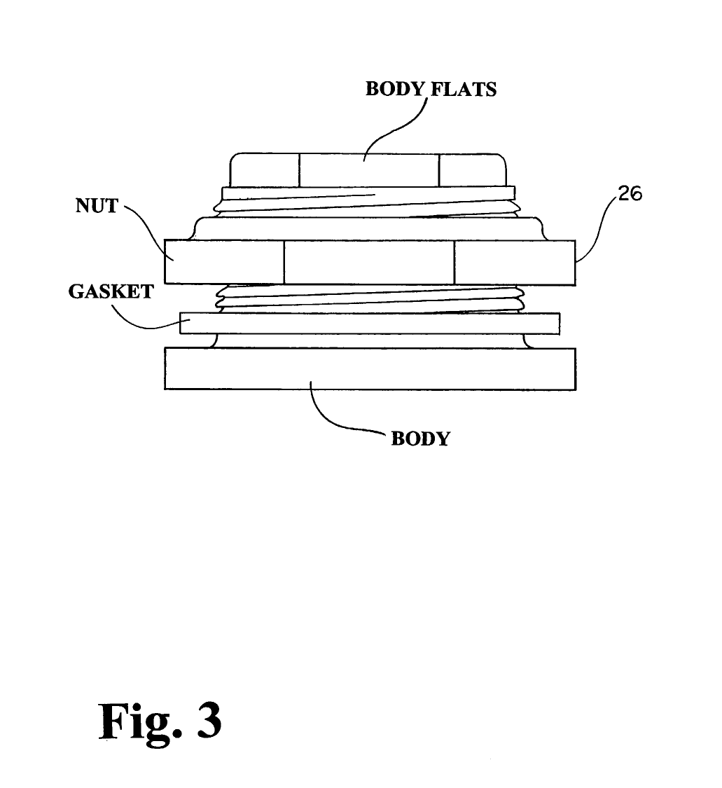

Referring to FIGS. 1-3, to provide for the indoor use of the power washing system (10), the housing (12) of the present invention is equipped with one or more bulkhead fittings (26). Each fitting (26) is designed to allow for the attachment of a vacuum line (28).

In one embodiment, one or more vacuum lines are channeled to a vacuum hose member (40). The vacuum hose member (40) is designed to allow easy attachment of external hoses (42) to the system (10). In fact, the vacuum hose member (40) is capable of releasably attaching to virtually any external hose (42). For example, external source hoses (42) from external devices such as shop vacuums, flood pumpers, carpet extractors and/or truck mount carpet cleaning machines may be conveniently attached to the hose member (40) of the present invention On one embodiment, the present invention is designed to accommodate 2.0″ and 1.5″ inside diameter vacuum base cuffs (not shown). The attachment of the vacuum line (28) to the housing (12) of the present invention allows the system (10) to accumulate sprayed water, dislodged particles and other contaminants for proper disposal. Thus, the present invention allows indoor surfaces to be efficiently cleaned without leaving wastewater or residue.

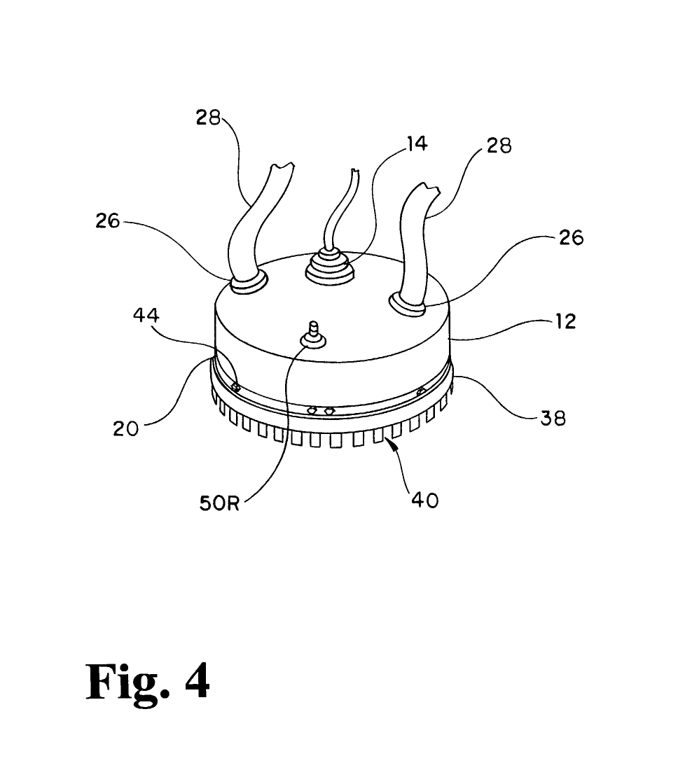

Referring to FIGS. 1-4, the power washing system of the present invention may be equipped with a variety of vacuum release mechanisms (50) to accommodate a wide assortment of cleaning surfaces. First, a vacuum release may be positioned adjacent to the vacuum hose member (40) to allow the consumer to manually adjust the amount of air allowed into the vacuum lines (28). Second, a spring-loaded vacuum release mechanism (50R) may be positioned adjacent to the neck (14) portion of the housing (12). By adjusting the spring loaded release, the consumer may increase or decrease the amount of air allowed to travel under the abrasion lip (20) of the housing (12). Third, one or more holes may be drilled into the housing (12) to be subsequently filled with bolts (44). The consumer may then remove one or more bolts (44) as desired to allow additional air to be present inside the housing (12) during cleaning. In one embodiment, the holes are about 3/16″ in diameter and stainless steel bolts are used to adjust airflow through the holes.

Referring back to FIG. 1, the housing (12) of the present invention is releasably attached to a support member (30) having a first end (30A) and a second end (30B). The first end (30A) of the support member (30) is attached to the housing (12) such that the consumer may manipulate housing as desired. In one embodiment, the second end (30B) of the support member (30) is equipped with a water source receiver (31) capable of releasably attaching to virtually any pressure washer or truck mount carpet cleaning machine.

The system (10) of the present invention is capable of utilizing any water source capable of providing between about 800 and about 4000 pounds per square inch (psi) of water pressure and having a minimum pump usage of between about 2.1 gallons per minute up to about 6 gallons per minute. Additionally, the present invention is capable of utilizing water having a temperature of between about 1 degree Celsius and about 101 degrees Celsius. In one embodiment, the system (10) of the present invention is capable of providing efficient cleaning without the use of cleaning chemicals. This is especially true in cleaning applications where the source water is at or above a temperature of about ninety degrees and delivered at a pressure at or above about 2000 psi.

The water source receiver (31) of the present invention is capable of attaching to virtually any water source. In one embodiment, any high pressure fluid connections may be used including, but not limited to, ⅜″ male pipe thread, 22 millimeter swivel, ⅜″ or ¼′ male or female quick disconnect units.

To provide the consumer with control over the system (10), the second end (30B) of the support member (30) of the present invention is equipped with a handle member (32) shaped to define a grasping portion (34). In one embodiment, the grasping portion (34) of the handle member (32) is equipped with a trigger (36) designed to control incoming water flow once the water source receiver (31) has connected to an external water supply. In one embodiment, the grasping portion (34) of the present invention is equipped with a securing mechanism (not shown) capable of securing the trigger (36) in a pre-selected position. In one embodiment, the securing mechanism comprises a cable tie (not shown) having a reusable releasable tab (not shown) capable of securing the trigger (36) in the desired position. In another embodiment, two grasping portions (34) are provided and equipped with ergonomic padding to provide the consumer with an enjoyable cleaning experience.

Referring to FIG. 5, the system (10) of the present invention is highly versatile and capable of efficient operation both indoors and outdoors. The present invention provides a brush lip (38) capable of releasable attachment to the abrasion lip (20). The brush lip (38) is equipped with cavities (40) for allowing water, dislodged particles and other contaminants to be removed from the cleaning area. This feature of the present invention allows the power washing system (10) to be used in a variety of outdoor applications where attachment of the vacuum system is not necessary. Additionally, the power washing system (10) of the present invention is equipped with a plurality of locking hitch pins as well as a plurality of fluid quick disconnects. This feature of the present invention allows the consumer to take the system (10) apart for storage in a short period of time.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim,

1. A mobile power washing system capable of moving over surface areas to be cleaned and adapted for spraying and retrieving water under high pressure, said system comprising:
a housing having upper and lower surfaces, said housing having a generally concave configuration and further defining a contact surface for engaging said surface areas;o
a neck member attached to said upper surface of said housing, said neck member capable of releasable attachment to one or more water hoses; and
a rotatable disbursement member positioned adjacent to said lower surface of said housing, said disbursement member being releasably attached to said neck member, said disbursement member having two or more adjustable water dispersing jets capable of directing water in a downwardly direction.

2. The system of claim 1, wherein said contact surface of said housing further comprises an abrasion lip for protecting said housing during operation of said system.

3. The system of claim 1, wherein said contact surface of said housing further comprises a brush lip.

4. The system of claim 2, wherein said abrasion lip is composed of plastic having a relatively high molecular weight.

5. The system of claim 1, wherein said housing further comprises one or more bulkhead fittings sized to receive one or more vacuum hoses.

6. The system of claim 1, wherein said housing is composed of polypropylene.

7. The system of claim 1, wherein said contact surface of said housing is generally circular in shape, said housing having a diameter of about 16 inches.

8. The system of claim 1, further comprising a support member having first and second ends, said support member attached to said upper surface of said housing at a first end and having a mounting member at a second end, said mounting member shaped to define a grasping portion.

9. The system of claim 8, wherein said mounting member releasably engages one or more water hoses and further comprises a trigger member adapted to control water flow through said hose.

10. The system of claim 1, wherein each of said water disbursing jets are adjustable with respect to said disbursement member.

11. The system of claim 1, wherein said disbursement member is threadably attached to said neck member of said housing such that said disbursement member is vertically adjustable.

12. The system of claim 5, wherein said housing further comprises one or more vacuum release mechanisms for increasing or decreasing the vacuum pressure within said housing of said system.

13. The system of claim 12, wherein said upper surface of said housing comprises at least one wall defining one or more cavities for receiving one or more stopper members.

14. The system of claim 13, wherein said cavities have a diameter of about 3/16 inches.

15. The system of claim 5, further comprising a main vacuum hose having a first end sized for releasable attachment to an external vacuum source and a second end sized for releasable attachment to one or more of said bulkhead fittings.

16. A mobile power washing system capable of moving over surface areas to be cleaned and adapted for spraying and retrieving water under high pressure, said system comprising:
a housing having upper and lower surfaces, said housing having a generally concave configuration and further defining a contact surface for engaging said surface areas;
a neck member attached to said upper surface of said housing, said neck member capable of releasable attachment to one or more water hoses;
a rotatable disbursement member positioned adjacent to said lower surface of said housing, said disbursement member being releasably attached to said neck member, said disbursement member having two or more adjustable water disbursing jets capable of directing water in a downwardly direction;
said contact surface of said housing further comprising an abrasion lip for protecting said housing during operation of said system;
said contact surface further comprising a brush lip capable of movement along said surface areas;
said housing having a generally circular shape and a diameter of about 16 inches;
a support member having first and second ends, said support member attached to said upper surface of said housing at a first end and having a mounting member at a second end, said mounting member shaped to define a grasping portion;
said mounting member having a trigger member adapted to control water flow through one or more water hoses releasably engaging said mounting member;
one or more bulkhead fittings sized to receive one or more vacuum hoses;
said disbursement member being threadably attached to said neck member of said housing such that said disbursement member is vertically adjustable; and
said housing further comprising one or more vacuum release mechanisms for increasing or decreasing the vacuum pressure within said housing.
